(19) United States
(12) Patent Application Publication
(10) Pub. No.: US 2013/0022132 A1
(43) Pub. Date: Jan. 24, 2013

(54) COMMUNICATION AMONG NETWORK DEVICES AT SUBSCRIBER PREMISES

(71) Applicants: Mark T. Paulsen, Excelsior, MN (US); Mark R. Biegert, Maple Grove, MN (US)

(72) Inventors: Mark T. Paulsen, Excelsior, MN (US); Mark R. Biegert, Maple Grove, MN (US)

(73) Assignee: Calix, Inc., Petaluma, CA (US)

(21) Appl. No.: 13/188,023

(22) Filed: Jul. 21, 2011

(51) Int. Cl. H04B 3/00

(52) U.S. Cl. 375/257

(57) ABSTRACT

One or more example techniques of this disclosure may be directed to providing a diversity of ways in which a network interface device may receive information from or transmit information to one or more of subscriber devices within a subscriber premises. For example, the network interface device may wirelessly transmit and receive information. The network interface device may also be coupled to a power supply device, and may receive information from and transmit information to the power supply device. The power supply device may receive information from and transmit information to the one or more of the subscriber devices utilizing wireless techniques and/or power line communication (PLC) techniques.

### TECHNICAL FIELD

This disclosure relates to networking, and more particularly, communication between a network interface device and devices at a subscriber premises.

### BACKGROUND

Network interface devices permit a subscriber to access a variety of information via a network. A passive optical network (PON), for example, can deliver voice, video and data among multiple network nodes, using a common optical fiber link. Passive optical splitters and combiners enable multiple optical network terminals (ONTs) to share the optical fiber link. Each ONT terminates the optical fiber link for a residential or business subscriber, and is sometimes referred to as a subscriber premises node that delivers Fiber to the Premises (FTTP) services.

In some systems, an ONT is connected with wiring to one or more subscriber devices in the subscriber premises, such as televisions, set-top boxes, telephones, computers, or network appliances, which ultimately receive the voice, video and data delivered via the PON. In this manner, the ONT can support delivery of telephone, television and Internet services to subscriber devices in the subscriber premises.

### SUMMARY

In general, this disclosure describes example techniques for providing diversity in the communication of information, e.g., reception and/or transmission of information, between a network interface device and one or more subscriber devices in a subscriber premises. For example, a network interface device may receive information from a network, and transmit the received information to a power supply device that provides power to the network interface device. The power supply device may be operable to wirelessly transmit the received information to one or more subscriber devices at the subscriber premises. The power supply device may also be operable to transmit the received information to the one or more subscriber devices through a power line in the subscriber premises.

The power supply device may be operable to wirelessly receive information from the one or more subscriber devices. The power supply device may also be operable to receive the information from the one or more subscriber devices through the power line in the subscriber premises. The power supply device may transmit the received information to the network interface device, which may then transmit the information to one or more devices on the network.

In one example, the disclosure describes a power supply device that includes a power supply operable to supply power to a network interface device, and a communication module operable to receive information from the network interface device, transmit information to one or more of a plurality of subscriber devices within a subscriber premises via a power line within the subscriber premises, and transmit information to one or more of the subscriber devices via a wireless interface.

In another example, the disclosure describes a method that includes supplying power, with a power supply device, to a network interface device, and with the power supply device, receiving information from the network interface device. The method also includes, with the power supply device, transmitting information to one or more of a plurality of subscriber devices within a subscriber premises via a wireless interface, and with the power supply device, transmitting information to one or more of the subscriber devices within the subscriber premises via a power line within the subscriber premises.

In another example, the disclosure describes a system that includes a plurality of subscriber devices at a subscriber premises, a power line within the subscriber premises, a wireless interface, a network interface device, and a power supply device. The power supply device is operable to supply power to the network interface device, transmit information to and receive information from the network interface device, transmit information to and receive information from one or more of the plurality of subscriber devices within the subscriber premises via the power line within the subscriber premises, and transmit information to and receive information from one or more of the subscriber devices via the wireless interface.

In another example, the disclosure describes a power supply device that includes means for supplying power to a network interface device, and means for receiving information from and transmitting information to the network interface device. The power supply device also includes means for transmitting information to and receiving information from one or more of a plurality of subscriber devices within a subscriber premises via a wireless interface, and mean for transmitting information to and receiving information from one or more of the plurality of subscriber devices within the subscriber premises via a power line within the subscriber premises.

In another example, the disclosure describes a power supply device that is operable to supply power to a network interface device, and receive information from the network interface device. The power supply device is further operable to transmit information to one or more of a plurality of subscriber devices within a subscriber premises via a wireless interface, and transmit information to one or more of the subscriber devices within the subscriber premises via a power line within the subscriber premises.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating a network, in accordance with one or more aspects of this disclosure.

FIG. 2 is a block diagram illustrating an example of subscriber devices within a subscriber premises, in accordance with one or more aspects of this disclosure.

FIG. 3 is a block diagram illustrating another example of subscriber devices within a subscriber premises, in accordance with one or more aspects of this disclosure.

FIG. 4 is a block diagram illustrating an example of an optical network terminal (ONT), in accordance with one or more aspects of this disclosure.

FIG. 5 is a block diagram illustrating an example of power supply device, in accordance with one or more aspects of this disclosure.

FIG. 6 is a block diagram illustrating another example of power supply device, in accordance with one or more aspects of this disclosure.

FIG. 7 is a flow chart illustrating an example operation of power supply device, in accordance with one or more aspects of this disclosure.

### DETAILED DESCRIPTION

A network interface device may receive information from and transmit information to one or more subscriber devices within a subscriber premises. The network interface device may be located proximate to the subscriber premises, e.g., inside the subscriber premises or connected to an exterior surface of the subscriber premises, and may transmit and receive information such as voice, video, and data. For example, the network interface device may receive information from a network, e.g., via an optical fiber link, a copper link, or a wireless link, and may transmit the received information to one or more subscriber devices within the subscriber premises such as television set-top boxes, telephones, desktops, laptops, gaming consoles, media players, or wireless routers, as well as various types of household appliances such as refrigerators, washers, and dryers. Similarly, the network interface device may receive information from the subscriber devices and transmit the received information over the network.

In some of the example implementations described in the disclosure, the network interface device may be coupled to or may include a wireless interface. As one example, the wireless interface may be built on the network interface device. As another example, the network interface device may include a port, and the port may couple the wireless interface to the network interface device. For example, the port may be a universal serial bus (USB) port, although other techniques to couple the network interface to the wireless interface may be possible. In this example, the wireless interface may be a USB dongle.

The network interface device may wirelessly communicate with one or more subscriber devices within or otherwise associated with the subscriber premises with the wireless interface. For example, the one or more of the subscriber devices may also include wireless interfaces. Each of the wireless interfaces of the subscriber devices may wirelessly transmit information to or wirelessly receive information from the wireless interface of the network interface device.

In some examples, the wireless interfaces for the one or more subscriber devices may transmit and receive information according to a specific protocol, including a proprietary protocol. For instance, the wireless interfaces for the one or more subscriber devices may transmit and receive information according to the Zigbee protocol, the 802.11x, e.g., 802.11 a/b/g/n, protocol, or Z-Wave protocol, as well as any other type of protocol. Moreover, the protocols used by the wireless interface for different subscriber devices may be different. For example, the wireless interface for one subscriber device may transmit and receive information according to the Zigbee protocol, and the wireless interface for another subscriber device may transmit and receive information according to the Z-Wave protocol.

In some examples, the wireless interface of the network interface device may be capable of transmitting and receiving information in accordance with the different types of protocols so that the network interface device can communicate with the different subscriber devices. In some alternate examples, the network interface device may include, or may be coupled to, different wireless interfaces. Each of these different wireless interfaces may communicate with different protocols. In this manner, the network interface device may be capable of communicating with the wireless interfaces of the one or more subscriber devices even when the wireless interfaces of the one or more subscriber devices are configured for different wireless protocols.

Wireless communication between the network interface device and the one or more subscriber devices may result in a reduction of cabling within the subscriber premises. For example, without wireless communication, the network interface device may need to be coupled to the subscriber devices with CAT-5 cables and/or coaxial cables. However, some subscriber premises may not have been built with extensive CAT-5 or coaxial cabling. Also, locations within the subscriber premises, where the one or more of the subscriber devices reside, may not provide easy access to CAT-5 cable adapters or coaxial cable adapters. With wireless communication, the network interface device and the one or more subscriber devices may be able to communicate with one another without requiring too much additional cabling. Also, with wireless communication, the subscriber devices need not necessarily be located in portions within the subscriber premises where CAT-5 or coaxial cable adapters are available.

Wireless communication between the network interface device and the one or more subscriber devices may be suitable for some applications, but there may be certain limitations. For example, if the network interface device is external to the subscriber premises, the wall of the subscriber premises may function as a barrier for wireless communication. For instance, the wall may attenuate or otherwise disrupt the signal transmitted or received by the network interface device. Also, wireless communication may be limited by bandwidth and range. For example, wireless communication may be limited in transmitting high-definition (HD) television and gaming information throughout the subscriber premises. Furthermore, in some examples, not all of the subscriber devices may be configured for wireless communication.

In some examples, in addition to or instead of wireless communication, some of the example implementations described in this disclosure may utilize the existing power lines within the subscriber premises, e.g., alternating current (AC) power lines, for communicating with the one or more subscriber devices. Techniques to utilize power lines for communication may be referred to as power line communication (PLC) techniques. The power line referred to in this disclosure may be the power line that extends throughout the subscriber premises and that, in some examples, carries alternating current (AC) voltage. For purposes of illustration only, the power line may be referred to as the AC power line.

In the PLC technique, information that is transmitted or received by the subscriber devices may be modulated onto the AC power line. For example, the AC power line is generally accessible through a socket or outlet which is connected to a wall within the subscriber premises. Many of the subscriber devices generally receive power through the sockets or outlets. In these examples, the subscriber devices may modulate the information that is to be transmitted on the AC power line through the sockets or outlets. Also, in these examples, the subscriber devices may receive modulated information on the AC power line through the sockets or outlets, and may demodulate the information to receive the transmitted information. PLC techniques may be advantageous for transmitting and receiving information because there may be more sockets or outlets within the subscriber premises, as compared to CAT-5 or coaxial cable adapters, making it easier to access a socket or outlet for transmission and reception of information.

However, there may be potential limitations with the PLC technique because, in some examples, the network interface device may not receive power via the AC power line. In these examples, the network interface device may not be capable of communicating via the AC power line. For example, rather than receiving power through a socket or outlet, the network interface device may receive power from a power supply device. Examples of the power supply device include, but are not limited to, an uninterruptible power supply (UPS) or a power adapter. For instance, the power supply device may couple to a socket or outlet to receive power via the AC power line. The power supply device may convert the received power into power that is usable by the network interface device. As one example, the power supply device may receive AC voltage from the socket, and convert the AC voltage into a direct current (DC) voltage. The network interface device may be capable of operating from the DC voltage supplied by the power supplying device.

In addition to supplying power to the network interface device, the power supply device may function as a bridge that allows the network interface device to access the AC power line for implementing PLC techniques. For example, the network interface device may receive information via the network. The network interface device may transmit the information to the power supply device. The power supply device, in turn, may transmit the information to the one or more subscriber devices utilizing the PLC technique.

Similarly, the one or more subscriber devices may transmit information to the power supply device utilizing the PLC technique. The power supply device may transmit the received information to the network interface device. The network interface device, in turn, may transmit the received information via the network. Although the network interface device may not be coupled to the AC power line, in this manner, the subscriber devices may be able to communicate with the network interface device utilizing the PLC techniques, which may be supported by the power supply device interposed between the network interface device and the AC power line. In this example, the network interface device and the one or more subscriber devices may still be able to communicate with one another utilizing the wireless techniques described above.

In some examples, the power supply device may include, or may be coupled to, a wireless interface. The wireless interface of the power supply device may be similar to, or different from, the wireless interface of the network interface device, as described above. In this example, the network interface device and power supply device may communicate with one another wirelessly or via a wired link.

In some alternate examples, the network interface device may not include, or may not be coupled, to a wireless interface, and the power supply device may include, or may be coupled, to a wireless interface. In these alternate examples, the power supply device may communicate with the one or more subscriber devices utilizing either the wireless communication techniques or PLC techniques, or both the wireless communication and PLC techniques. The power supply device may communicate with the network interface device utilizing a wired link.

Utilizing wireless communication techniques in conjunction with PLC techniques may provide the network interface device and the subscriber devices with a diversity of communication techniques. For example, the network interface device may instruct the power supply device to determine a quality of service (QoS) metric for wireless communication and PLC, e.g., communication via the AC power line. The QoS metric may indicate the transmission and reception capabilities of the wireless communication techniques and the PLC techniques, and may be based on example factors such as signal-to-noise ratio (SNR), packet retry rate, bit error rate, bit rate, or any combination thereof. The power supply device may transmit the determined QoS metrics to the network interface device. The network interface device may compare the received QoS metrics and instruct the power supply device to transmit and receive information via the communication technique that provided the higher QoS metric, e.g., selectively transmit and receive information using the wireless communication technique or the PLC technique based on the determined QoS metrics for each. In alternate examples, the power supply device may determine the QoS metrics and select the manner in which to transmit and receive information without being instructed to do so by the network interface device.

For example, the network interface device or the power supply device may determine that wireless transmission of information may not be received by the one or more subscriber device due to the bandwidth and range limitations of the wireless communication. In this example, the power supply device or the network interface device may determine that transmission of information utilizing the PLC techniques, instead of wireless communication techniques, may allow the subscriber devices to receive the information. In this example, the subscriber devices may receive the information via the AC power line, instead of wirelessly.

In an alternate example, the opposite situation may arise. For example, the power supply device or the network interface device may determine that one or more the subscriber devices may not receive information that is transmitted utilizing the PLC techniques, but may receive information this is transmitted utilizing wireless communication techniques. In this example, the power supply device or the network interface device may transmit the information wirelessly, and the subscriber devices may receive the information wirelessly, instead of via the AC power line.

The diversity of communication techniques may also allow the network interface device and the power supply device to simultaneously communicate with the subscriber devices utilizing both wireless and power line communication techniques. For example, two different subscriber devices may need to receive different information simultaneously. The network interface device or the power supply device may determine that transmitting the information to both of these subscriber devices utilizing only wireless communication techniques or only PLC techniques may not be feasible (e.g., due to bandwidth, SNR, packet retry rate, bit error rate, or bit rate).

To address this, as one example, the power supply device may transmit information to one of the two subscriber device utilizing wireless communication techniques, and transmit information to the other of the two subscriber devices utilizing PLC techniques. In this manner, the power supply device may be able to simultaneously communicate with subscriber devices that are transmitting and receiving different information without consuming excessive wireless bandwidth and without overloading the AC power line with information that is to be received by the subscriber devices.

Moreover, aspects of this disclosure may be extendable to different systems as well. For instance, the example techniques described in this disclosure may be useable in a smart-home and/or smart-grid system. In the smart-home or smart-grid system, a provider of power to the subscriber premises, referred to as a utility provider, may desire to measure the power usage at the subscriber premises, and/or the power usage of the subscriber devices, on a fairly regular basis, e.g., minute-by-minute, hour-by-hour, day-by-day, week-by-week, or month-by-month basis. The utility provider may charge the owner of the subscriber premises different rates based on the measured power usage. For example, the utility provider may charge the owner of the subscriber premises a higher rate during the peak usage hours, and a lower rate throughout the rest of the day.

In some these examples, the utility provider may couple a power meter to the AC power line of the subscriber premises that measures the power usage of the subscriber premises. The power meter may output the measured amount of power usage, through a wired link, to the network interface device. The network interface device may then periodically transmit the measured amount of power usage to the utility provider as defined by the utility provider.

In an alternate example, the power meter may output the measured amount of power usage on the AC power line. In this example, the power supply device may receive the output from the power meter, and may transmit the measured amount of power usage to the network interface device, which in turn transmits the measured amount of power usage to the utility provider.

As part of the smart-home system, the one or more of the subscriber devices may measure their own power usage, and transmit the measured power usage to the network interface device utilizing either or both the wireless communication technique and the PLC technique. In an alternate example, the one or more subscriber devices may transmit their measured power usage to a common device, which may be the thermostat, as one example. The network interface device may receive the measured power usage from the common device utilizing either or both the wireless communication technique and the PLC technique, e.g., via the power supply device. In either example, the network interface device may transmit the measured power usage to the utility provider.

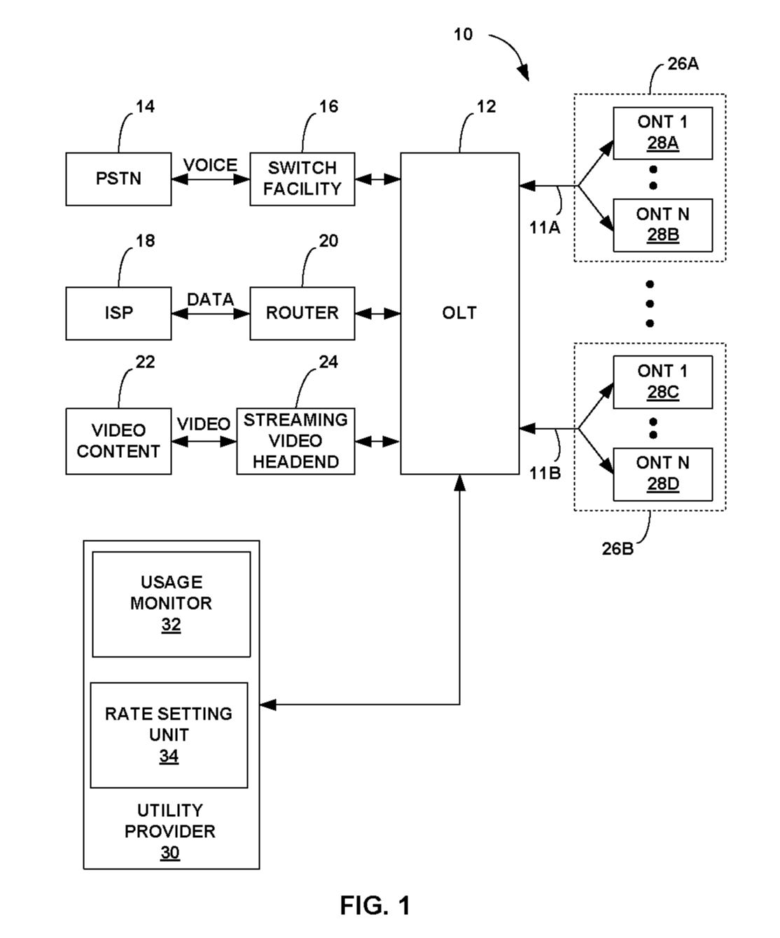

FIG. 1 is a block diagram illustrating a network 10. For purposes of illustration, the example implementations described in this disclosure are described in context of an optical network, e.g., a passive optical network (PON). Accordingly, network 10 may be referred to as PON 10. However, aspects of this disclosure are not so limited, and can be extended to other types of networks such as cable or digital subscriber line (DSL) based networks, or Active Ethernet which may be considered as optical transmission and reception in accordance with the Ethernet protocol. Active Ethernet is defined by the IEEE 802.3ah standard, e.g., in clause 59 of the 802.3ah standard.

As shown in FIG. 1, PON 10 may deliver voice, data and video content (generally “information”) to a number of network nodes via optical fiber links. In some examples, PON 10 may be arranged to deliver Internet Protocol television (IPTV) and other high speed information, i.e., information transmitted at approximately 200 Mbps or higher. PON 10 may conform to any of a variety of PON standards, such as the broadband PON (BPON) standard (ITU G.983) or the gigabit-capable PON (GPON) standard (ITU G.984), as well as future PON standards under development by the Full Service Access Network (FSAN) Group, such as 10G GPON (ITU G.987), or other organizations.

Optical line terminal (OLT) 12 may receive voice information, for example, from the public switched telephone network (PSTN) 14 via a switch facility 16. In addition, OLT 12 may be coupled to one or more Internet service providers (ISP's) 18 via the Internet and a router 20. As further shown in FIG. 1, OLT 12 may receive video content 22 from video content suppliers via a streaming video headend 24. Video also may be provided as packet video over the Internet. In each case, OLT 12 receives the information, and distributes it along optical fiber links 11A and 11B (collectively “fiber links 11”) to groups 26A and 26B (collectively “groups 26”) of optical network terminals (ONTs) 28A, 28B, 28C and 28D (collectively “ONTs 28”). Each of groups 26 is coupled to a respective one of optical fiber links 11. OLT 12 may be coupled to any number of fiber links 11. For purposes of illustration, FIG. 1 shows only two fiber links 11A, 11B.

A single ONT 28 is an example of a network interface device. Other examples of a network interface device include, but are not limited to, a cable modem or a DSL modem. However, for purposes of illustration but without limitation, the example implementations described in the disclosure are described in the context of the network interface device being an optical network terminal (ONT).

Each one of ONTs 28 may reside at or near a subscriber premises. The subscriber premises may be a home, a business, a school, or the like. A single ONT 28 may be capable of transmitting information to and receiving information from one or more subscriber premises. In some examples, a single ONT 28 may directly transmit information to or receive information from one or more subscriber devices (not shown) within the subscriber premises. Examples of the subscriber devices include, but are not limited to, one or more computers (e.g., laptop and desktop computers), network appliances, televisions, game consoles, set-top boxes, wireless devices, media players or the like, for video and data services, and one or more telephones for voice services. The subscriber devices may also include household appliances such as furnaces, washer and dryers, freezers, refrigerators, thermostats, lights, security systems, and the like. In examples where the subscriber devices are household appliances, the household appliances may receive information such as configuration information from ONT 28 and transmit information such as confirmation information, as well as power usage information. The power usage information may include information such as on and off times and power consumption.

The single ONT 28 may wirelessly communicate with one or more of the subscriber devices, e.g., wirelessly transmit information to and wirelessly receive information from one or more of the subscriber devices. Wireless communication between the single ONT 28 and one or more of the subscriber devices may be advantageous in reducing the amount of cabling, such as CAT-5 or coaxial cabling, required for communication. For instance, the subscriber premises may not be equipped with extensive cabling. Also, the one or more subscriber devices may not include adapters for the cabling, or may not be located near adapters for the cabling within the subscriber premises. Wireless communication may allow the single ONT 28 to transmit information to and receive information from one or more of the subscriber devices without requiring extensive cabling or additional cabling within the subscriber premises.

However, wireless communication may be limited by bandwidth and range. For example, there may not be sufficient wireless bandwidth for ONT 28 to wirelessly transmit high-definition (HD) video or gaming information. As another example, the strength of the wireless communication may not be sufficient to reach the subscriber devices.

There may be additional limitations with ONT 28 transmitting and receiving information wirelessly. For example, ONT 28 may be located external to the subscriber premises. The external walls of the subscriber premises may attenuate or otherwise disrupt the wireless transmission of information and the wireless reception of information by ONT 28. As another example, not all of the subscriber devices may be capable of receiving and transmitting information wirelessly.

To address some of these potential limitations of wireless communication, some of the example implementations described in the disclosure may describe a diversity of ways in which ONT 28 receives and transmits information, while minimizing the amount of cabling, e.g., CAT-5 or coaxial cabling, required for transmission and reception of information. For example, the subscriber devices require power for operation, and such power is generally provided via a power line that extends throughout the subscriber premises, such as alternating current (AC) power lines. For purposes of illustration only, the techniques of this disclosure are described with examples where the power line is an AC power line; however, examples described this disclosure should not be considered so limiting. In some examples, the subscriber devices may utilize the existing AC power lines to receive information from and transmit information to ONT 28. The reception and transmission of information via the power line within the subscriber premises may be referred to as power line communication (PLC) techniques.

However, ONT 28 may not be coupled to the same AC power lines that couple to the subscriber devices. In some examples, each of ONTs 28 receives power via respective power supply devices (not shown). For instance, a power supply device is coupled to the AC power line that extends within the subscriber premises, and is also coupled to a single ONT 28. The power supply device may receive AC voltage, from the AC power line, convert the AC voltage to a direct current (DC) voltage, and supply the DC voltage to the single ONT 28. The single ONT 28 may operate from the DC voltage provided by the power supply device.

As one example, each of ONTs 28 is coupled to its respective power supply device via an Ethernet line and a separate DC power line, or an Ethernet line that includes the ability to deliver power, sometimes referred to as power-over-Ethernet (PoE). The power supply device provides AC-to-DC voltage conversion from alternating current (AC) line power within the subscriber's premises. Examples of the power supply device include, but are not limited to, a power adapter or an uninterruptible power supply (UPS) unit. In examples where the power supply device is a UPS unit, the power supply device may include a battery for backup power to maintain critical services such as voice communication during a power failure. The power supply device may be connected to the AC power line provided by the subscriber premises with a standard AC power cord.

Each one of ONTs 28 may not, by itself, be able to transmit and receive information via the AC power line because ONTs 28 may not be coupled to the AC power line. To transmit and receive information via the AC power line, as will be described in detail, a single ONT 28 may transmit information to its power supply device via the Ethernet line that does not include a DC power line, or the PoE line, and may, in some examples, wirelessly transmit information to the power supply device. The power supply device may then transmit the received information, from ONT 28, to one or more of the subscriber devices via the AC power line. In some examples, the power supply device may also be capable of wirelessly transmitting the received information, from ONT 28, to one or more of the subscriber devices.

Similarly, the power supply device may receive information from one or more of the subscriber devices via the AC power line and/or wirelessly receive the information from one or more of the subscriber devices. The power supply device may transmit the received information, from one or more of the subscriber devices, to its respective ONT 28 via the Ethernet line that does not include the DC power line, or the PoE line. In some examples, the power supply device may also be capable of wirelessly transmitting the received information, from one or more of the subscriber devices, to its respective ONT 28.

In some examples of this disclosure, the power supply device may transmit information to and receive information from the one or more subscriber devices based on the quality of communication. For example, there may be a particular level of quality of service (QoS) that the power supply device can achieve by wireless communication techniques or PLC techniques at a given time. The level of the QoS may be represented by a QoS metric (e.g., a bigger QoS metric means a higher quality of service, and a lower QoS metric means a lower quality of service). The QoS metric may be based on example factors such as signal-to-noise ratio (SNR), packet retry rate, bit error rate, bit rate, or any combination thereof for each of these communication channels (e.g., wireless communication or communication via the AC power line).

Each one of ONTs 28 or its respective power supply device may determine the QoS metric utilizing established techniques or techniques that are developed in the future. For example, wireless communication protocols or PLC protocols may define techniques for calculating parameters such as SNR, packet retry rate, bit error rate, and/or bit rate. Each one of ONTs 28 or its respective power supply device may utilize similar techniques to determine the QoS metric. Furthermore, each one of ONTs 28 and its respective power supply device may utilize additional or different parameters to determine the QoS metric.

The QoS metric for wireless communication and the QoS metric for communication via the AC power line may indicate which of these two communication channels is better suited for communication at a given time. The power supply device may communicate with the one or more subscriber devices via the AC power line if the QoS metric for communication via the AC power line is greater than the QoS for wireless communication. Similarly, in this example, the power supply device may wirelessly communicate with the one or more subscriber devices if the QoS metric for wireless communication is greater than the QoS for communication via the AC power line. In this manner, the power supply device may selectively communicate with one or more of the subscriber devices utilizing either wireless communication techniques or PLC techniques.

It should be understood that although the preceding example describes wireless communication or communication via the AC power line as an either/or technique, e.g., selectively communicate with the subscriber devices utilizing either the AC power line or communicate wirelessly, aspects of this disclosure are not so limited. In some examples, the power supply device may be capable of communicating with one or more the subscriber devices utilizing both power line communication over the AC power line and wireless communication techniques.

For example, it may be possible that the power supply device needs to communicate, e.g., transmit or receive information, with two or more subscriber devices simultaneously. In this example, each one of ONTs 28 or its corresponding power supply device may determine that it is not feasible to communicate with the two or more subscriber devices utilizing only wireless communication or communication via the AC power line.

For instance, each one of ONTs 28 or its corresponding power supply device may estimate the QoS metric if the power supply device were to communicate with the two or more subscriber devices utilizing only the AC power line. Each one of ONTs 28 or its corresponding power supply device may also estimate the QoS metric if the power supply device were to communicate with the two or more subscriber devices utilizing only wireless communication. In some cases, it may be possible that the both of these QoS metrics are less than an overall desired QoS metric.

To address this, in some of these situations, the power supply device may communicate with some of the subscriber devices utilizing the AC power line, and may communicate with the other subscriber devices utilizing wireless communication. In this manner, each one of ONTs 28 may be able to communicate with respective subscriber devices without consuming excessive wireless bandwidth or overloading the AC power line. Also, in this manner, the power supply device may be able to maintain a minimum desired quality of service.

In some instances, some subscriber devices may be capable of communicating using wireless communication techniques or PLC techniques, but not both. In these situations, the power supply device may communicate with such subscriber devices using the communication technique with which such subscriber devices can communicate. In these examples, the power supply device may be able to communicate with different subscriber devices simultaneously. For instance, the power supply device may communicate with one subscriber device that can only communicate using PLC techniques, and simultaneously communication with another subscriber device that can only communicate using wireless communication techniques.

As will be described in detail, ONTs 28 include hardware for bidirectional communication with PON 10 via links 11 and one or more connected subscriber devices. In addition, each ONT 28 may be connected to subscriber telephones for delivery of telephone services. Hence, ONT 28 may provide information in the form of video to support television applications, information to support Internet access, and voice to support telephone services. OLT 12 may be located near or far from a group 26 of ONTs 28. However, OLT 12 is typically located in a telecommunication company central office (CO), while ONTs 28 may be located at any of a variety of locations, including residential, educational or business premises.

In some examples, PON 10 may also allow utility provider 30 to monitor the power usage of the subscriber premises where ONTs 28 reside. It should be understood that PON 10 need not allow utility provider 30 to monitor the power usage of the subscriber premises in every example. The ability of utility provider 30 to monitor power usage of the subscriber premises may be beneficial for a smart-home and/or smart-grid system.

Utility provider 30 may provide power to the subscriber premises via AC power lines that extend from utility provider 30 to the subscriber premises. Utility provider 30 may charge the owner of the subscriber premises a fee based on the amount of power consumption. In the smart-home and/or smart-grid system, utility provider 30 may consider it desirable to charge the owner of the subscriber premises different rates during different usage periods. For example, utility provider 30 may charge a higher rate during peak power consumption, and charge a lower rate during other times.

To determine the power consumption behavior of the subscriber premises, utility provider 30 may measure the power consumption, e.g., number of Watts (W), at the subscriber premises and/or power usage information of one or more of the subscriber devices, e.g., power consumption and on and off times, on a fairly regular basis, e.g., minute-by-minute, hour-by-hour, day-by-day, week-by-week, or month-by-month. It may not be cost effective for utility provider 30 to repeatedly send a technician to measure the power consumption at the subscriber premises. Accordingly, utility provider 30 may consider it desirable to receive power usage information directly from the subscriber premises.

For cost effective power consumption monitoring, a technician may, during an initial visit, attach a power meter to the AC power line at the subscriber premises. The power meter may measure the total amount of power used by the subscriber premises, and transmit the measured amount of power consumption to respective ONTs 28. ONTs 28 may then transmit the measured amount of power consumption to utility provider 30 via fiber link 11 and OLT 12. In some examples, ONTs 28 may transmit the measured amount of power consumption at times set by utility provider 30, e.g., minute-by-minute, hour-by-hour, day-by-day, week-by-week, or month-by-month.

The power meter may transmit the measured amount of power consumption to ONTs 28 utilizing various different techniques. As one example, the power meter may be coupled directly to respective ONTs 28. For example, the power meter may be wired to respective ONTs 28, and may transmit the measured amount of power consumption to ONTs 28 via the wired connection. As another example, the power meter may wirelessly transmit the measured amount of power consumption to ONTs 28. As yet another example, the power meter may transmit the measured amount of power consumption via the AC power line at the subscriber premises to the power supply device, which in turn transmits the measured amount of power consumption to its respective one of ONTs 28. In some examples, the power meter may utilize any combination of the above example techniques to transmit the measured amount of power consumption to ONTs 28.

Instead of or in addition to transmitting the total measured amount of power consumption, ONTs 28 may also transmit the power usage information of one or more of the subscriber devices. The power usage information may include times of operation, e.g., on and off times, and the amount of power consumption. ONTs 28 may receive power usage information from one or more of the subscriber devices at predefined times, or as the information becomes available.

For example, a subscriber device may transmit its respective power usage information to ONTs 28 utilizing either the wireless communication technique or the PLC technique based on QoS metrics. For example, the power supply device may transmit information to the subscriber device using either the wireless communication technique or the PLC technique based on QoS metrics that indicates to the subscriber device that it should transmit information back to the power supply device using the same selected communication technique. For example, if the power supply device may instruct the subscriber device to either transmit information using the wireless communication technique or the PLC technique. If, however, the subscriber device is capable of communicating using only one of the wireless communication technique or the PLC technique, then the power supply device may communicate with the subscriber device using the communication technique with which the subscriber device is capable of communicating. The power supply device may then transmit the power usage information to its respective one of ONTs 28, which in turn transmits the power usage information of the subscriber devices to utility provider 30 via fiber links 11.

In some alternate examples, one or more of the subscriber devices may transmit their power usage information to a common subscriber device such as the thermostat at the subscriber premises. In this example, the common subscriber device may then transmit the power usage information to respective ONTs 28 and/or power supply devices in manners similar to those described above. The common subscriber device may allow ONTs 28 and/or power supply devices to not necessarily interface with every single subscriber device within the subscriber premises.

Utility provider 32 of utility provider 30 may receive the power consumption from the power meter and, possibly, the power usage information from one or more of the subscriber devices via ONTs 28. Usage monitor 32 may transmit this information to rate setting unit 34 of utility provider 30. Rate setting unit 34 may then set the rates, i.e., monetary pricing, that the owner of the subscriber premises pays utility provider 30 for the consumption of power.

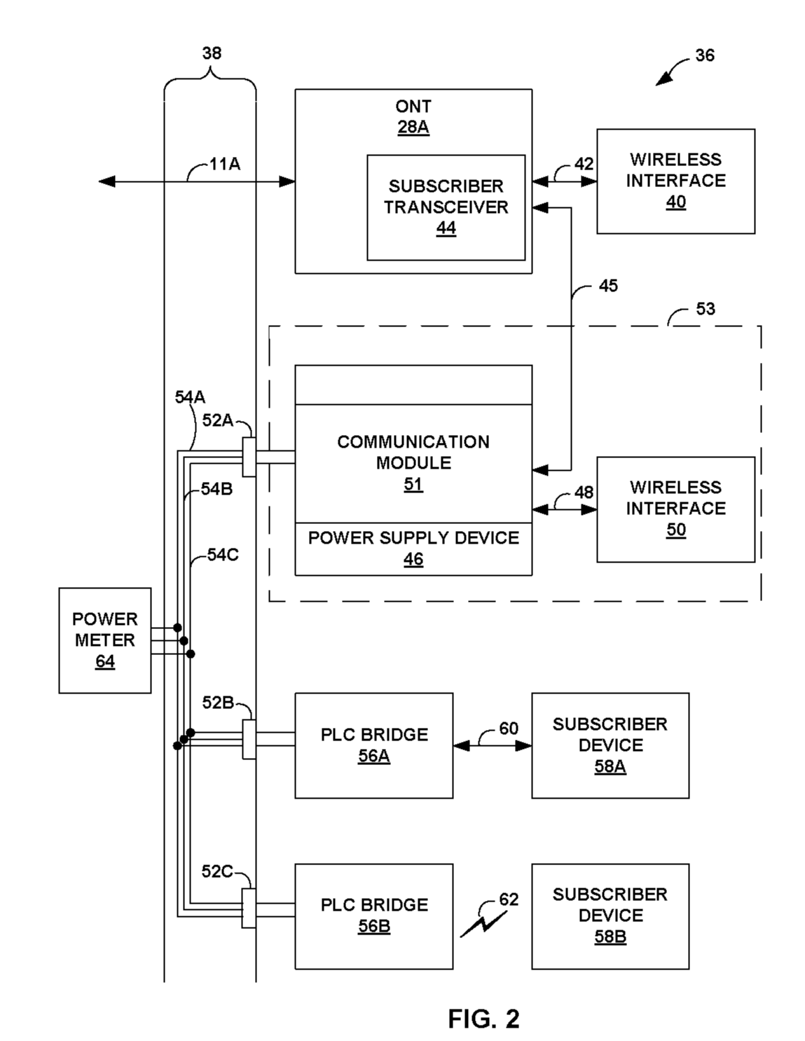

FIG. 2 is a block diagram illustrating an example of subscriber premises 36. Subscriber premises 36 may be, e.g., a residential premise, education premise, or a business premise. As illustrated in FIG. 2, ONT 28A may be inside subscriber premises 36, e.g., on the right side of wall 38. Accordingly, optical fiber link 11A, with which ONT 28A receives information from and transmits information to OTL 12, is coupled to ONT 28 through wall 38.

ONT 28A may include subscriber transceiver 44, and may transmit and receive information via subscriber transceiver 44. For example, ONT 28A may receive information from OLT 12, and subscriber transceiver 44 may convert the optical signal to an electrical signal that represents the received information, transmit the received information to one or more of the subscriber devices, such as subscriber devices 58A and 58B, within subscriber premises 36. Similarly, subscriber transceiver 44 may receive information from one or more of the subscriber devices, e.g., subscriber devices 58A and 58B, convert the received information, received as an electrical signal, into an optical signal, and transmit the received information via fiber link 11A. In some examples, subscriber transceiver 44 may also receive the total amount of power consumption at subscriber premises 36 from power meter 64. Although not shown, in some examples, subscriber transceiver 44 may also be coupled to telephone lines that extend to telephones in subscriber premises 36, and may receive and transmit voice information via the telephone lines. In alternate examples, subscriber transceiver 44 may transmit and receive voice information, as well as data and video information, via line 45, as described below.

There may be variety of techniques with which subscriber transceiver 44 may transmit and/or receive information, providing communication diversity. In general, the techniques for transmission and/or reception of information may include wireless techniques that utilize one or more of wireless interfaces 40 and 50, and may also include power line communication (PLC) techniques that utilize power line 54, which may be, as one example, an AC power line and referred to as AC power line 54, that extends throughout subscriber premises 36. In some examples, ONT 28A may determine whether higher communication quality can be achieved by transmitting and receiving information using wireless communication techniques or PLC techniques. In these examples, ONT 28A may choose the communication technique that provides higher or more reliable communication quality. In this manner, there may be additional assurance that the information is properly received or transmitted.

For example, subscriber transceiver 44 may transmit information to and receive information from wireless interface 40. As illustrated in FIG. 2, subscriber transceiver 44 may be coupled to wireless interface 40 via line 42. As one example, line 42 may be a universal serial bus (USB), and in this example, wireless interface 40 may be a USB dongle with a wireless communication transceiver, although other ways to couple wireless interface to subscriber transceiver 44 may be possible. In alternate examples, wireless interface 40 may be formed on ONT 28A, and in these alternate examples line 42 may be not be necessary. However, some examples of ONT 28A may not have been built with wireless interface 40, and for these situations wireless interface 40 may be coupled to ONT 28A via line 42.

Wireless interface 40 may receive information from subscriber transceiver 44 and wirelessly transmit the received information to subscriber devices 58A and 58B that are capable of wirelessly receiving information. Similarly, for subscriber devices that are capable of wirelessly transmitting information, wireless interface 40 may wirelessly receive such information and transmit the received information to subscriber transceiver 44.

Wireless interface 40 may utilize various protocols, including standard and/or proprietary protocols, to transmit and receive information. For instance, wireless interface 40 may wirelessly transmit and receive information to one or more of the subscriber devices according to the Zigbee protocol, the 802.11x, e.g., 802.11g/n, protocol, or Z-Wave protocol, as well as any other type of protocol. Moreover, the protocols used by wireless interface 40 may be different for different subscriber devices. For example, one subscriber device may transmit and receive information according to the Zigbee protocol, and another subscriber device may transmit and receive information according to the Z-Wave protocol.

In some examples, wireless interface 40 may be capable of transmitting and receiving information in accordance with the different types of protocols so that ONT 28A can communicate with the different subscriber devices. In some alternate examples, ONT 28A may include, or may be coupled to, different wireless interfaces similar to wireless interface 40. Each of these different wireless interfaces may communicate with different protocols. In this manner, ONT 28A may be capable of wirelessly communicating, e.g., wirelessly transmitting information to and receiving information from, one or more of the subscriber devices even when the wireless interfaces of one or more of the subscriber devices are configured for different wireless protocols.

In some instances, relying solely on wireless interface 40 to transmit and receive information may not ensure that the information is properly received or transmitted by subscriber transceiver 44 with respect to the subscriber devices. For example, if subscriber device 58A or 58B is a laptop computer that is displaying high-definition content, e.g., video or games, wireless interface 40 may not include sufficient bandwidth and range for such content to reach subscriber device 58A or 58B. As another example, if ONT 28A is external to subscriber premises 36, wall 38 may function to attenuate or otherwise disrupt the wireless communication making it difficult for wireless interface 40 to communicate with one or more of the subscriber devices. As yet another example, subscriber device 58A or 58B may not be capable of receiving and transmitting information wirelessly. In these situations, wireless interface 40 may not be able to communicate with subscriber device 58A or 58B. Due to some of the potential limitations of wireless interface 40, wireless interface 40 may not be necessary in every example. However, wireless interface 40 may be included, in any event, as providing at least one way for ONT 28A to communicate with one or more of the subscriber devices.

To assist in some of the limitations of wireless interface 40, power supply system 53 may function as a bridge that allows ONT 28A to not rely solely on wireless interface 40 for transmission and reception of information. Power supply system 53 may include power supply device 46 and wireless interface 50. Power supply device 46 may be tasked with supplying power to ONT 28A, as well as transmitting information to and receiving information from ONT 28A.

To supply power to ONT 28A, power supply device 46 is coupled to outlet 52A, and receives AC voltage from AC power line 54 through outlet 52A. Power supply device 46 may convert the AC voltage to DC voltage and supply the DC voltage to ONT 28A via line 45. In some example, the DC voltage may be approximately −48 volts (V) DC; however, aspects of this disclosure are not so limited. Examples of power supply device 46 include, but are not limited to, an uninterruptible power supply (UPS) unit and a power adapter.

As illustrated in FIG. 2, power supply device 46 may be coupled to ONT 28A via line 45. In some examples, line 45 may be a single line that includes both Ethernet and power lines, sometimes referred to as power over Ethernet (PoE). In these examples, ONT 28A may receive power via the power lines of the PoE, and subscriber transceiver 44 may communicate with power supply device 46 with the Ethernet lines of the PoE. As another example, line 45 may be two separate lines. A first line may be an Ethernet line, a coaxial cable, or a CAT-5 cable, and a second line may be a DC power line. In this example, subscriber transceiver 44 and power supply device 46 may communicate via the first line, and ONT 28A may receive power via the second line.

In the example of FIG. 2, power supply device 46 may receive information from subscriber transceiver 44 via line 45, and may transmit the received information utilizing the PLC technique and/or the wireless technique. Similarly, power supply device 46 may receive information from one or more of the subscriber devices, e.g., subscriber devices 58A and 58B, utilizing the PLC technique and/or the wireless technique, and transmit the received information to subscriber transceiver 44 via line 45.

In some examples, it may be possible for power supply device 46 to wirelessly receive information from and transmit information to subscriber transceiver 44. For example, wireless interface 40, of ONT 28A, and wireless interface 50, of power supply device 46, may wirelessly transmit information to and receive information from one another.

As illustrated in FIG. 2, to communicate with subscriber devices 58A and 58B, power supply device 46 may include communication module 51. Communication module 51 may include a PLC interface that allows communication module 51 to implement PLC techniques to communicate with subscriber devices 58A and 58B via the AC power line 54. Communication module 51 may also include a port that allows communication module 51 to couple to wireless interface 50, with which communication module 51 may wirelessly communicate with subscriber devices 58A and 58B. For example, in examples where wireless interface 50 is a USB dongle, the port of communication module 51 may be a USB port. In examples where wireless interface 50 is a part of power supply device 46, communication module 51 may include wireless interface 50.

The PLC interface of communication module 51 may communicate with subscriber devices 58A and 58B using the HomePlug AV or a different power line communication technology. For example, power supply device 46 receives information from subscriber transceiver 44, and the PLC interface of communication module 51 modulates the received data onto power line 54 via outlet 52A. As illustrated, power line 54 may include positive line 54A, ground line 54B, and negative line 54C. Power line 54 may deliver 120 volts (V) AC, as is common in North America, or 240 VAC, as is common in Europe and Asia, or any other desirable voltage level.

PLC bridges 56A and 56B may be coupled to outlets 52B and 52C, respectively. PLC bridges 56A and 56B may provide AC power to subscriber devices 58A and 58B, respectively. In alternate examples, subscriber devices 58A and 58B may receive AC power from different outlets, e.g., not through PLC bridges 56A and 56B. In either example, subscriber devices 58A and 58B may receive information via their respective PLC bridges 56A and 56B. Although not illustrated as such, in some examples, PLC bridges 56A and 56B may be integrated within respective ones of subscriber devices 58A and 58B.

For example, PLC bridges 56A and 56B may demodulate information received from power line 54, and transmit the demodulated data to subscriber devices 58A and 58B. In the example of FIG. 2, PLC bridge 56A may demodulate the received information from power line 54, and transmit the demodulated information to subscriber device 58A via line 60, which may be an Ethernet line, as one example. PLC bridge 56B may demodulate the received information from power line 54, and may wirelessly transmit the demodulated information to subscriber device 58B. Bolt 62, in FIG. 2, indicates wireless communication between PLC bridge 56B and subscriber device 58B.

In the reverse, subscriber devices 58A and 58B may transmit information to their respective PLC bridges 56A and 56B. PLC bridges 56A and 56B may modulate the received information from subscriber devices 58A and 58B onto AC power line 54. The PLC interface of communication module 51 may receive the information from AC power line 54 and demodulate the received information. Power supply device 46 may then transmit the information to subscriber transceiver 44.

To communicate with one or more of the subscriber devices utilizing wireless techniques, communication module 51 may be coupled to wireless interface 50. For instance, communication module 51 may include a port, such as a USB port as a non-limiting example, and communication module 51 may be coupled to wireless interface 50 via the port. In alternate examples, wireless interface 50 may be built on power supply 46. For instance, wireless interface 50 may be a part of communication module 51. In the example of FIG. 2, power supply device 46 may communicate with wireless interface 50 via line 48. Similar to line 42, line 48 may be a universal serial bus (USB), and in this example, wireless interface 50 may be USB dongle.

Wireless interface 50 may receive information from power supply device 46 (e.g., from communication module 51) and wirelessly transmit the received information to subscriber devices 58A and 58B. Similarly, for subscriber devices that are capable of wirelessly transmitting information, wireless interface 50 may wirelessly receive such information and transmit the received information to power supply device 46 (e.g., via communication module 51).

Wireless interface 50 may be similar to wireless interface 40. For example, wireless interface 50 may transmit information to and receive information from one or more of the subscriber devices according to the Zigbee protocol, the 802.11x, e.g., 802.11g/n, protocol, or Z-Wave protocol, as well as any other type of protocol. In some examples, wireless interface 50 may be capable of transmitting and receiving information in accordance with the different types of protocols so that communication module 51 can communicate with the different subscriber devices. In some alternate examples, communication module 51 may include, or may be coupled to, different wireless interfaces similar to wireless interface 50. Each of these different wireless interfaces may communicate with different protocols. In this manner, communication module 51, and thereby power supply device 46, may be capable of wirelessly communicating, e.g., wirelessly transmitting information to and receiving information from, one or more of the subscriber devices even when the wireless interfaces of one or more of the subscriber devices are configured for different wireless protocols.

As one example, power supply device 46, via communication module 51, may receive information from ONT 28A via line 45, and it may also be possible for wireless interface 50 to receive the same information wirelessly from wireless interface 40. Communication module 51 may transmit the received information to wireless interface 50 via line 48. Wireless interface 50 may then transmit the information to one or more of the subscriber devices that are capable of receiving information wirelessly, e.g., subscriber device 58B. In addition to, or in the alternate, wireless interface 50 may wirelessly forward the received information from wireless interface 40 to subscriber device 58B, in this example.

Similarly, wireless interface 50 may wirelessly receive information from one or more of the subscriber devices, e.g., subscriber device 58B, that are capable of transmitting information wirelessly. Wireless interface 50 may transmit the received information to communication module 51 via line 48, which in turn transmits the information to subscriber transceiver 44 of ONT 28A via line 45. In some examples, wireless interface 50 may wirelessly transmit the information to wireless interface 40, which in turn transmits the information to subscriber transceiver 44 of ONT 28A via line 42.

By utilizing the techniques described above, ONT 28A may transmit and receive information, e.g., voice, video, data, confirmation signals, status signals, power usage information, and any other type of information, utilizing many different techniques. Such diversity of information communication may ensure that the information is properly received and transmitted, while minimizing the amount of additional cabling within subscriber premises 36. For example, as described above, ONT 28A may utilize wireless interface 40 and/or power supply device 46 to transmit information to and receive information from subscriber devices 58A and 58B.

Power supply device 46 may be operable to utilize wireless and PLC techniques to communicate with subscriber devices 58A and 58B (e.g., with communication module 51). For example, the PLC interface of communication module 51 may utilize PLC techniques for communicating with subscriber devices 58A and/or 58B, and wireless interface 50 may utilize wireless techniques for communicating with subscriber devices 58A and/or 58B. In some examples, when power supply device 46 is to communicate with a specific one of the one or more subscriber devices, communication module 51 of power supply device 46 may communicate with the specific one of the one or more subscriber devices utilizing one of the wireless communication technique or PLC technique based on the quality of service (QoS) metric, assuming that the specific subscriber device is capable of communicating using either wireless communication techniques or PLC techniques. In some examples, when power supply device 46 is to simultaneously communicate with multiple subscriber devices, communication module 51 may utilize both wireless communication and PLC techniques. Each of these examples is described in greater detail below.

For example, assume that ONT 28A received information that is to be transmitted specifically to subscriber device 58B. Also assume that subscriber device 58B is capable of communicating using both wireless communication and PLC techniques. In some cases, ONT 28A may instruct power supply device 46 to determine quality of service (QoS) metrics for transmission of the information to subscriber device 58B using wireless communication techniques and PLC techniques. In some alternate cases, power supply device 46 may determine the QoS metrics without specific instruction from ONT 28A.

To determine QoS metrics for transmission using PLC techniques, the PLC interface of communication module 51 may determine parameters such as signal-to-noise ratio (SNR), packet retry rate, bit error rate, bit rate, or any combination thereof for transmission via power line 54. To determine QoS metrics for transmission using wireless communication techniques, wireless interface 50 may determine similar parameters. The PLC interface of communication module 51 and wireless interface 50 may implement any known technique, or technique that is to be developed in the future to determine the QoS parameters. For example, wireless communication protocols and PLC protocols define techniques with which to determine these example QoS parameters, and the PLC interface of communication module 51 and wireless interface 50 may implement any of the techniques to determine the example QoS parameters.

In some examples, power supply device 46 may transmit the QoS parameters to ONT 28A for ONT 28A to determine whether power supply device 46 should transmit the information using PLC techniques or wireless communication techniques. ONT 28A may determine a QoS metric for transmission using PLC techniques and a QoS metric for transmission using wireless communication based on the received QoS parameters. Based on the determined QoS metrics, ONT 28A may determine whether communication module 51 should transmit the information to subscriber device 58B using PLC or wireless communication techniques, and indicate to communication module 51 whether it should transmit the information using wireless communication or PLC techniques.

For example, if the QoS metric for wireless communication techniques is greater than the QoS metric for PLC techniques, communication module 51 may transmit the information to subscriber device 58B using wireless communication techniques, and vice-versa if the QoS metric for the PLC techniques is greater than the QoS metric for wireless communication techniques. In alternate examples, rather than ONT 28A instructing power supply device 46 to determine the QoS parameter and ONT 28A determining the QoS metrics, power supply device 46 may perform such determinations. In these alternate examples, power supply device 46 may select whether to transmit information using PLC or wireless communication techniques, and may cause communication module 51 to perform communication in accordance with the selected technique.

Although the above example is described with respect to the transmission of information, power supply device 46 may function substantially similarly for the reception of information. For instance, subscriber device 58B may determine whether it should transmit information to power supply device 46 using PLC or wireless communication techniques based on QoS metrics similar to those described above. As another example, power supply device 46 or ONT 28A may determine the QoS metrics and indicate to subscriber device 58B whether subscriber device 58B should transmit information using PLC or wireless communication techniques.

In some examples, communication module 51 may transmit and receive information using PLC techniques and wireless communication techniques simultaneously. For example, power supply device 46 may need to transmit information to subscriber devices 58A and 58B at the same time. In this example, the information that is to be transmitted to subscriber devices 58A and 58B may be the same information or different information. In this example, power supply device 46, under the guidance of ONT 28A or otherwise, may determine QoS metrics for transmission of the information to both subscriber devices 58A and 58B if communication module 51 were to transmit the information using only PLC techniques or wireless communication techniques.

In some situations, it may be possible that the QoS metrics for both transmission techniques (e.g., wireless communication and PLC techniques) is less than a desired overall QoS metric. For example, the determined QoS metric, if communication module 51 were to transmit all of the information using only PLC techniques, may be less than a desired overall QoS metric for power line communication. Similarly, the determined QoS metric, if communication module 51 were to transmit all of the information using only wireless communication techniques, may be less than a desired overall QoS metric for wireless communication.

In these situations, as one example, communication module 51 may utilize both PLC techniques and wireless communication techniques to transmit information to subscriber devices 58A and 58B. For example, communication module 51 may utilize wireless communication techniques to transmit information to subscriber device 58B, and utilize PLC techniques to transmit information to subscriber device 58A. The QoS metrics for each of these transmission techniques may be less than the overall desired QoS metrics for each of these transmission techniques because the amount of information that communication module 51 is transmitting using these transmission techniques is reduced.

As an illustrative example, the bandwidth needed to transmit information to both subscriber devices 58A and 58B using only PLC techniques may be greater than the amount of available bandwidth. Also, the bandwidth needed to transmit information to both subscriber devices 58A and 58B using only wireless communication techniques may be greater than the available bandwidth. In this example, power supply device 46, with communication module 51, may transmit information to subscriber device 58A using PLC techniques so that the consumed bandwidth is within the amount of available bandwidth, and transmit information to subscriber device 58B using wireless communication techniques so that the consumed bandwidth is within the amount of available bandwidth. In this manner, the diversity of communication techniques may allow subscriber devices 58A and 58B to accurately and reliably receive information.

Similar to above, although the above example is described with respect to the transmission of information, communication module 51 may function substantially similarly for the reception of information, in the above example. For instance, communication module 51 may be capable of receiving information from subscriber devices 58A and 58B using both wireless communication and PLC techniques. For example, subscriber device 58A may transmit information to power supply device 46 utilizing PLC techniques, and, at the same time, subscriber device 58B may transmit information to power supply device 46 utilizing wireless communication techniques.

Furthermore, in some examples, communication module 51 may transmit information to or receive information from the same subscriber device at the same time using both wireless communication and PLC techniques. For example, communication module 51 may transmit information to subscriber device 58A using PLC techniques via the PLC interface of communication module 51, and, at the same time, transmit information to subscriber device 58A using wireless communication techniques via wireless interface 50. Similarly, communication module 51 may receive information from subscriber device 58A using PLC techniques, and, at the same time, receive information from subscriber device 58A using wireless communication techniques.

Moreover, in some examples, certain types of information may be better suited for PLC techniques compared to wireless communication techniques, or vice-versa. For example, high-definition video or gaming information may not be well suited for wireless communication. In these examples, for high-definition video or gaming information, communication module 51 may utilize only PLC communication techniques, and not utilize wireless communication techniques.

Also, as described above, techniques described in the disclosure may be usable in the smart-home/smart-grid system. For example, subscriber devices 58A and 58B may transmit their respective power usage information, e.g., power consumption and on and off times, to ONT 28A utilizing the above techniques, and ONT 28A may forward such information to utility provider 30 for the smart-home/smart-grid system. As an alternate example, subscriber device 58A may be tasked with communicating with all other subscriber devices, e.g., subscriber device 58B. In this example, subscriber device 58B may transmit and receive information from subscriber device 58A, which received information from and transmitted information to power supply device 46 utilizing the above example techniques. For example, subscriber device 58B may transmit its power usage information to subscriber device 58A. Subscriber device 58A may then transmit its own power usage information and the power usage information of subscriber device 58B to power supply device 46. Power supply device 46 may then forward the power usage information of subscriber devices 58A and 58B to ONT 28A for further transmission to utility provider 30.

In some examples, power meter 64 may measure the total amount of power consumption. However, power meter 64 may not be necessary in every example. For ease of installation, power meter 64 may be installed external to subscriber premises 36; although it may be possible for power meter 64 to be installed within subscriber premises 36.

In the example of FIG. 2, power meter 64 may be coupled to AC power line 54, and may transmit the measured total amount of power consumption, e.g., in Watts (W), to the PLC interface of communication module 51 utilizing the PLC techniques, e.g., via AC power line 54. Communication module 51 may then forward the measured total amount of power consumption to subscriber transceiver 44 via line 45. ONT 28A may then forward the measured total amount of power consumption to utility provider 30.

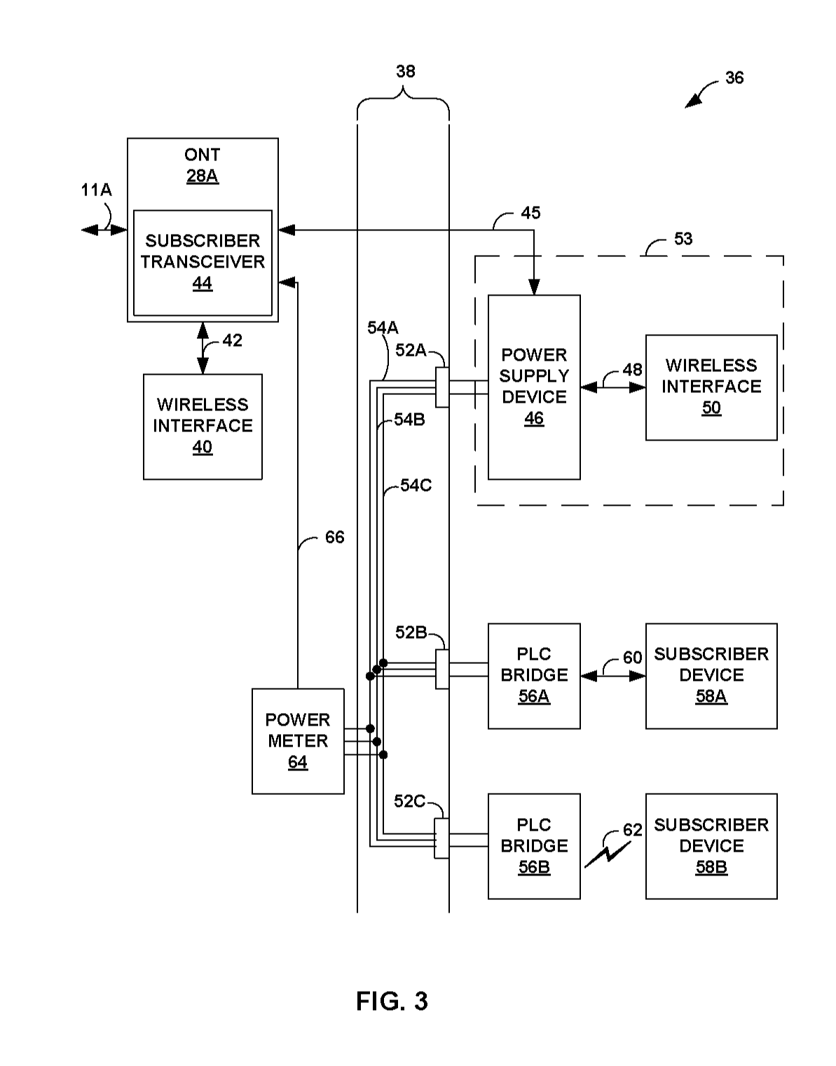

FIG. 3 is a block diagram illustrating another example of subscriber premises 36. Subscriber premises 36, as illustrated in FIG. 3, may be substantially similar to subscriber premises 36, as illustrated in FIG. 2. However, in the example of FIG. 3, ONT 28A may be external to subscriber premises 36, e.g., on the left side of wall 36 in FIG. 3. For purposes of brevity, only the differences between the examples illustrated in FIG. 2 and FIG. 3 are described.

In the example illustrated in FIG. 3, because ONT 28A resides external to subscriber premises 36, e.g., on the left side of wall 38, line 45 extends from subscriber transceiver 44 of ONT 28A through wall 38 and to power supply device 46. In some examples, subscriber transceiver 44 may also include connections to the telephones within subscriber premises 36. Although not illustrated in FIG. 3, these telephone lines may also extend through wall 38. In some examples, line 45 may also provide telephonic communication, and in these examples, there may be no need for telephone lines that extend through wall 38.

Also, in the example illustrated in FIG. 3, power meter 64 may be directly coupled to ONT 28A via line 66, which may be an Ethernet line, as one example. The direct connection between power meter 64 and ONT 28A may be possible in FIG. 3 because power meter 64 and ONT 28A may be external to subscriber premises 36. In this example, rather than transmitting total amount of power consumption utilizing the PLC technique, power meter 64 may transmit the total amount of power consumption to ONT 28A via line 66. In some examples, power meter 64 may include a wireless interface, and may be able to wirelessly transmit the total amount of power consumption to wireless interface 40. In these examples, power meter 64 may wirelessly transmit and/or transmit, via a wired connection, the total amount of power consumption to ONT 28A.

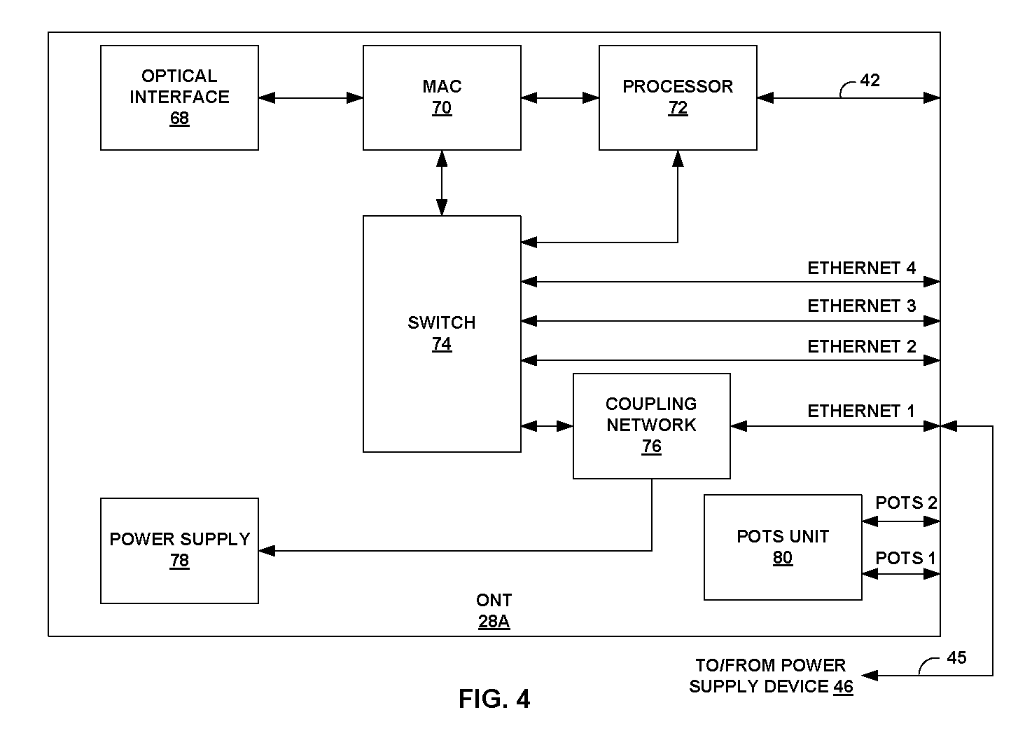

FIG. 4 is a block diagram illustrating an example of ONT 28A. ONTs 28B-28D may include substantially similar components. ONT 28A may include optical interface 68, media access controller (MAC) 70, processor 72, switch 74, coupling network 76, power supply 78, and plain old telephone service (POTS) unit 80. One or more of these components may form subscriber transceiver 44.

ONT 28A may include additional components not shown in FIG. 4 for purposes clarity. Moreover, not all of the components illustrated in FIG. 4 may be necessary in every example of ONT 28A. For instance, switch 74, coupling network 76, and POTS unit 80 may not be necessary in every example of ONT 28A. For example, as illustrated in FIG. 4, ONT 28A includes four Ethernet lines. If ONT 28A included only one Ethernet line, switch 74 may not be necessary. As another example, MAC 70 may transmit and receive voice information through one of the Ethernet lines, and in these examples, ONT 28A may not include POTS unit 80.

Optical interface 68, of ONT 28A, may receive and transmit information via fiber link 11A. For example, optical interface 68 may include a photo-diode and a transimpedance amplifier to receive optical information, i.e., downstream from OLT 12 (FIG. 1). Optical interface 68 may also include a laser driver to transmit optical information, i.e., upstream to OLT 12.

As illustrated, optical interface 68 may be coupled to MAC 70. MAC 70 may implement at least a portion of the data link layer, or layer 2, of the open systems interconnection (OSI) model. MAC 70 may provide addressing and channel access control mechanisms that enable one or more of the subscriber devices, e.g., subscriber devices 58A and 58B, to shader a given fiber link, such as fiber link 11A. MAC 70 may further convert physical layer signals to distinct data units, such as ATM cells or Ethernet frames, for transmission to the one or more of the subscriber devices. In the reverse, MAC 70 may convert information received by one or more of the subscriber devices into physical layer signals for transmission to OLT 12.

Processor 72 may receive the information from MAC 70, and may transmit the received information to wireless interface 40 via line 42. Similarly, processor 72 may receive information from wireless interface 40 via line 42. Processor 72 may also modify the received information from MAC 70 so that it can be transmitted by wireless interface 40 utilizing one or more wireless protocols. In the reverse, processor 72 may receive information from wireless 40 in accordance with one or more wireless protocols, convert the information so that it can be received by MAC 70, and transmit the information to MAC 70 for transmission via optical interface 68.

Processor 72 may also transmit information to switch 74 for transmission to one or more of the subscriber devices, and may also receive information from switch 74 from one or more of the subscriber devices. Switch 74 may allow ONT 28A to transmit and receive information via any one or more of Ethernet lines 1-4. MAC 70 may select which Ethernet line to use for the transmission and reception of information.

In some examples, processor 72 may also transmit instructions to power supply device 46 to determine the QoS metrics for wireless communication and power line communication, as described above. In some of these examples, processor 72 may also determine the manner in which power supply device 46 should communicate with one or more of the subscriber devices. For example, processor 72 may compare the QoS metrics and select either wireless communication or power line communication for communication with a subscriber device. As another example, processor 72 may store an overall desired QoS metrics for both wireless and power line communication techniques. In this example, processor 72 may determine whether some of the information should be transmitted using PLC techniques to some subscriber devices, and whether some of the information should be transmitted using wireless communication techniques to other subscriber devices. Processor 72 may then instruct power supply device 46 to communicate with the subscriber devices in the selected manner, and communication module 51 may selectively communicate with the subscriber devices in accordance with the selected manner.

In alternate examples, processor 72 may not perform functions related to QoS metrics. In these examples, power supply device 46 may be tasked with performing such functions related to QoS metrics. However, because it may be possible for processor 72 to perform more complex functions than a processing unit or units of power supply device 46, processor 72 may be a suitable option for performing some or all of the functions related to QoS metrics.

Examples of processor 72 include, but are not limited to, a digital signal processor (DSP), a general purpose microprocessor, an application specific integrated circuit (ASIC), a field programmable logic array (FPGA), or other equivalent integrated or discrete logic circuitry. Examples of switch 74 include, but are not limited to, any switching device that allows MAC 70 and processor 72 to select any one of Ethernet lines 1-4. For example, switch 74 may be a multiplexer (MUX).

In the example of FIG. 4, Ethernet line 1 may be the line 45 with which ONT 28 communicates with power supply device 46. In this example, Ethernet line 1 may be coupled to coupling network 76. Coupling network 76 may transmits information to and receive both information from power supply device 46, and may also receive power from power supply device 46, e.g., DC voltage. Coupling network 76 may include a high-pass filter that filters out the DC voltage supplied by power supply device, and the output of the high-pass filter may be the information that is received by one or more of the subscriber devices, or information that is to be transmitted to the one or more subscriber devices. Coupling network 76 may also include a low-pass filter that filters out the information that is received or that is to be transmitted by ONT 28, and the output of the low-pass filter may be the DC voltage that powers ONT 28A.

For example, coupling network 76 may provide the DC voltage to power supply 78. Power supply 78 may then supply power to one or more components of ONT 28A. For example, although not shown in FIG. 4, power supply 78 may be coupled to optical interface 68, MAC 70, processor 72, switch 74, and POTS unit 80, and may supply operating power to these components.

POTS unit 80 may be utilized for voice information. For example, POTS unit 80 may include POTS lines 1 and 2. Each of POTS lines 1 and 2 may be coupled to telephones. Although not shown, MAC 70 may be coupled to POTS unit 80. POTS unit 80 may transmit received voice information to MAC 70, and may receive voice information from MAC 70. As described above, in some examples, POTS unit 80 may not be necessary if voice information is transmitted and received via power supply device 46 through line 45 (e.g., as digital voice over IP (VoIP)).

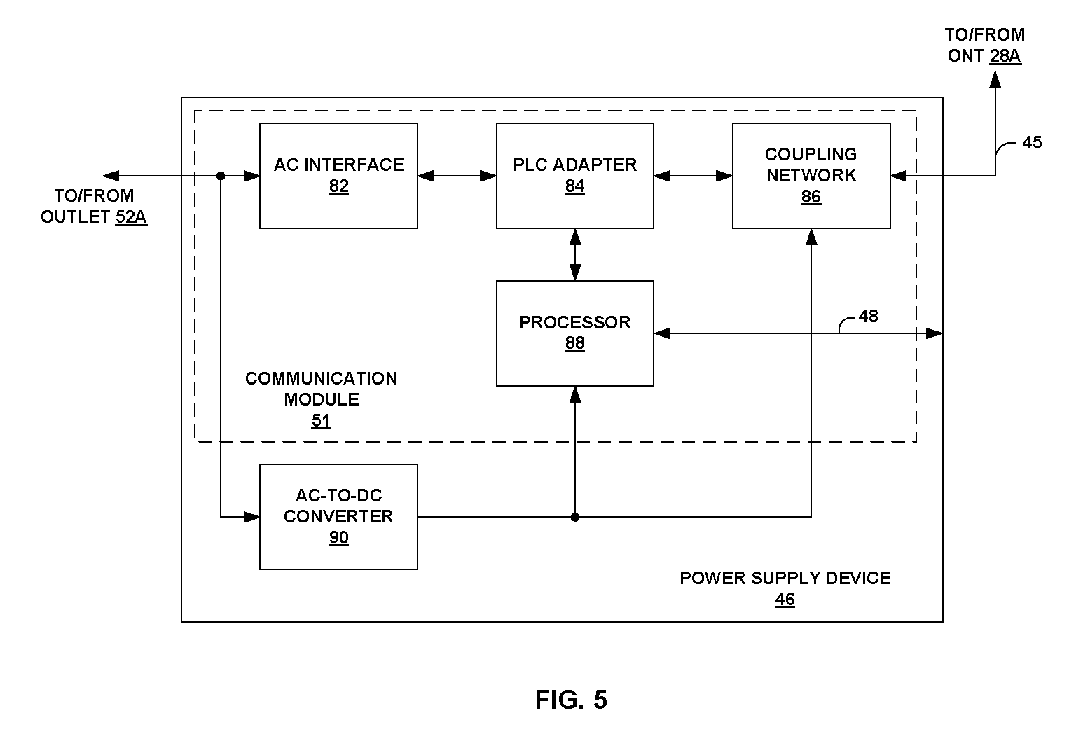

FIG. 5 is a block diagram illustrating an example of power supply device 46. In the example of FIG. 5, power supply device 46 may be a power adapter. AC-to-DC converter 90 receives AC power from outlet 52A via AC power line 54, and converts the AC power into DC power. AC-to-DC converter 90 provides the power to coupling network 86, which in turns supplies the power to ONT 28A via line 45. In this manner, AC-to-DC converter 90 may be viewed as a power supply that supplied power to ONT 28A. AC-to-DC converter 90 also may supply power to other components of power supply device 46 such as processor 88.

In the example of FIG. 5, AC interface 82, PLC adapter 84, coupling network 86, and processor 88 may be part of communication module 51. Communication module 51 may include additional or fewer components than those illustrated in FIG. 5. For instance, communication module 51 may include a port that allows wireless interface 50 to couple to power supply device 46. Communication module 51 should be considered as a general module that may include one or more components that allow power supply device 46 to communicate using wireless communication or PLC techniques. Communication module 51 should not be considered limited to the specific illustrated components.

Coupling network 86 may be similar to coupling network 76 of FIG. 4. For example, coupling network 86 may receive information from or transmit information to ONT 28A. To transmit information, coupling network 86 may transmit the information onto line 45, and to receive information, coupling network 86 may extract the information from line 45. Coupling network 86 may also receive the power from AC-to-DC converter 90, and couple the DC power onto line 45 for ONT 28A.

PLC adapter 84 may be an adapter that receives information from ONT 28A and converts the received information into information that can be transmitted over AC power line 54. For example, PLC adapter 84 may convert the received information in accordance with the HomePlug 1.0, HomePlug AV, HomePlug AV2, HomePlug GreenPhy, and HomePlug Access BPL specifications. Also, PLC adapter 84 receives information from one or more of the subscriber devices via AC power line 54 and converts the received information into information that is usable by ONT 28A, e.g., Ethernet frames. AC interface 82 may modulate the information received from PLC adapter 84 for transmission via AC power line 54. AC interface 82 may demodulate the information received from one or more of the subscriber devices for transmission to PLC adapter 84.

Processor 88 may be similar to processor 72 of FIG. 4. In some alternate examples, processor 88 may be limited in its processing capabilities, as compared to processor 72. For example, processor 72 may be able to perform more complex tasks, in a more efficient manner, than processor 88. In some examples, reduction in performance capabilities of processor 88 may allow power supply device 46 to be easily replaceable, and potentially more reliable.

Processor 88 may receive information for PLC adapter 84. Processor 88 may convert the information for transmission via wireless interface 50. For example, processor 88 may convert the information in accordance with the protocol with which wireless interface 50 transmits and receives information. Processor 88 may transmit the information to wireless interface 50 via line 48, and potentially a port of power supply device 46 connected to line 48. In the reverse, processor 88 may receive information from wireless interface 50, and may convert the information into information usable by PLC adapter 84 for transmission to ONT 28A.

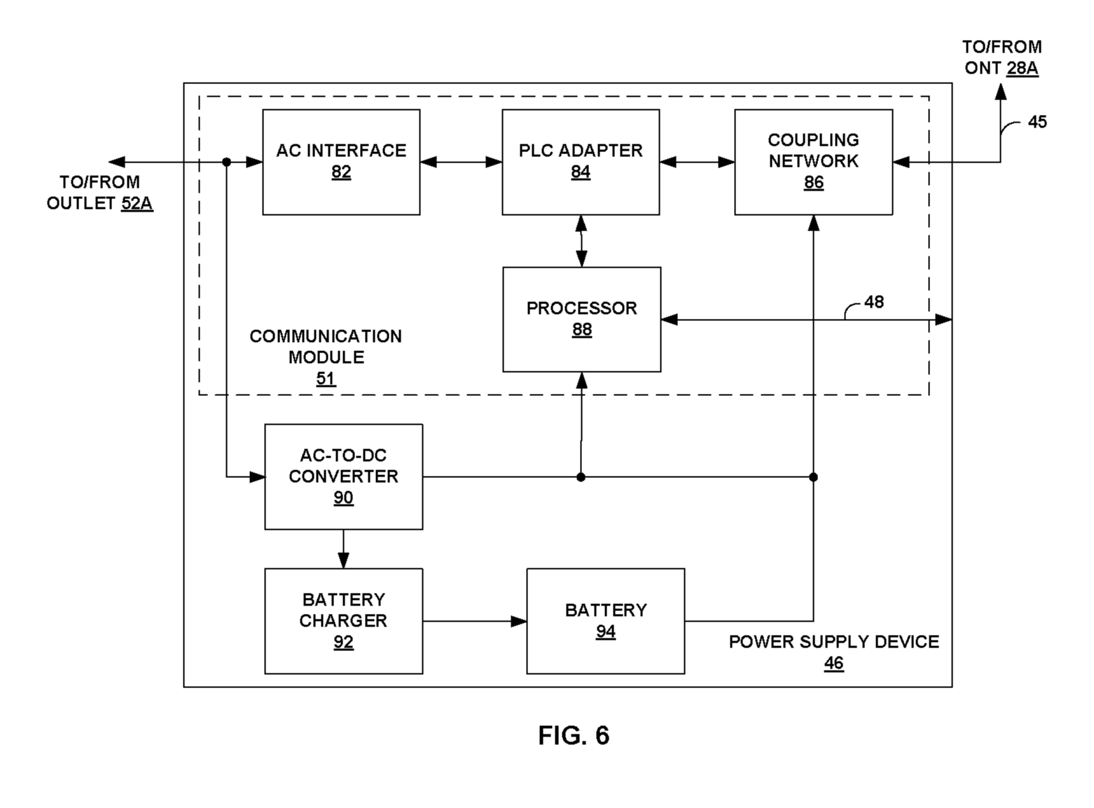

FIG. 6 is a block diagram illustrating another example of power supply device 46. In the example of FIG. 6, power supply device 46 may be an uninterruptible power supply (UPS) unit. For example, as illustrated in FIG. 6, power supply device 46 may also include battery charger 92 and battery 94. Battery charger 92 may receive DC voltage from AC-to-DC converter 90, and may charge battery 94. Battery 94 may provide backup DC voltage during power outages where AC voltage from power line 54 is unavailable. Battery 94 may maintain critical services, such as voice service, during power outage.

In some examples, power supply device 46 may also include a power over Ethernet (PoE) controller. For example, if power supply device 46 transmits and receives information using a power over Ethernet line, power supply device 46 may include the PoE controller. The PoE controller may be coupled to AC-to-DC converter 90 and may receive DC voltage from AC-to-DC converter 90. The PoE controller may convert the received DC voltage into voltage required for PoE, e.g., approximately −48 V DC.

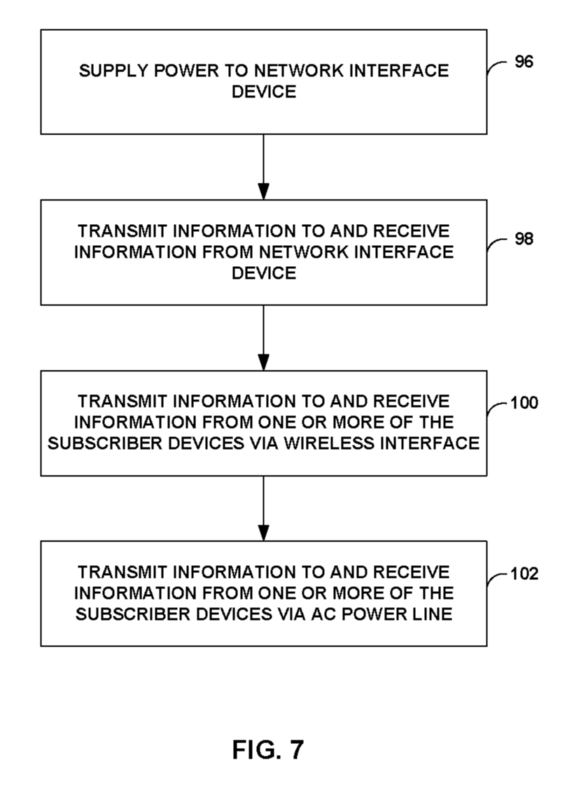

FIG. 7 is a flow chart illustrating an example operation of power supply device 46. For purposes of illustration, reference is made to FIGS. 2 and 3. For example, power supply device 46 may supply power to a network interface device, e.g., ONT 28A (96). For instance, AC-to-DC converter 90 may be an example of a power supply that supplies power to ONT 28A. Power supply device 46 may transmit information to and receive information from the network interface device (98). In some examples, power supply device 46 may transmit information to and receive information from the network interface device via wireless interface 50.

Power supply device 46 may transmit information to and receive information from one or more of the subscriber devices within subscriber premises 36, e.g., subscriber devices 58A and 58B, via wireless interface 50 (100). For example, for subscriber devices that are capable of wireless communication, one way in which power supply device 46 may communicate with such subscriber devices is via wireless interface 50. Power supply device 46 may also transmit information to and receive information from one or more of the subscriber devices via a power line, e.g., AC power line 54 (102). For example, power supply device 46 may modulate the information onto AC power line 54 to transmit information, and demodulate the information on AC power line 54 to receive information. In some examples, the information that power supply device 46 transmits and receives via wireless interface 50 may be substantially similar to the information that power supply device 46 transmits and receives via AC power line 54.

In some examples, power supply device 46 may transmit information to or receive information from a particular subscriber device using either the wireless communication techniques or the PLC techniques based on determined parameters of the QoS metrics. For example, power supply device 46 may be operable to selectively transmit information to or receive information from at least one of the plurality of subscriber devices using either wireless interface 50 or AC power line 54.

In some examples, power supply device 46 may transmit information to or receive information from two or more subscriber devices using both wireless communication and PLC techniques based on determined QoS metrics. For example, power supply device 46 may transmit information to or receive information from a first one of the plurality of subscriber devices via wireless interface 50, and, simultaneously, transmit information to or receive information from a second one of the plurality of subscriber devices via AC power line 54.

The techniques described herein may be implemented in hardware, software, firmware, or any combination thereof. Various features described as modules, units or components may be implemented together in an integrated logic device or separately as discrete but interoperable logic devices or other hardware devices, including optical hardware components. In some cases, various features of electronic circuitry may be implemented as one or more integrated circuit devices, such as an integrated circuit chip or chipset.

Various aspects have been described in this disclosure. These and other aspects are within the scope of the following claims.

1. A power supply device comprising:
a power supply operable to supply power to a network interface device; and
a communication module operable to receive information from the network interface device, transmit information to one or more of a plurality of subscriber devices within a subscriber premises via a power line within the subscriber premises, and transmit information to one or more of the subscriber devices via a wireless interface.

2. The power supply device of claim 1, wherein the communication module is further operable to selectively transmit information to or receive information from at least one of the plurality of subscriber devices via either the wireless interface or the power line.

3. The power supply device of claim 2, wherein the communication module is operable to receive instructions that indicate whether the communication module should selectively transmit information to or receive information from the at least one of the plurality of subscriber devices via either the wireless interface or the power line.

4. The power supply device of claim 2, wherein communication module selectively transmits information to or receives information from the at least one of the plurality of subscriber devices via either the wireless interface or the power line based on one or more of a signal-to-noise ratio (SNR), a packet retry rate, a bit error rate, and a bit rate associated with transmitting and receiving information via the power line and via the wireless interface.

5. The power supply device of claim 1, wherein the communication module is further operable to transmit information to the network interface device, receive information from one or more of the subscriber devices via the power line within the subscriber premises, and receive information from one or more of the subscriber devices via the wireless interface.

6. The power supply device of claim 1, wherein the power line within the subscriber premises comprises an alternating current (AC) power line that extends within the subscriber premises.

7. The power supply device of claim 1, wherein the wireless interface is coupled to the communication module.

8. The power supply device of claim 1, wherein the communication module includes the wireless interface.

9. The power supply device of claim 1, wherein the communication module is further operable to transmit information to or receive information from a first one of the plurality of subscriber devices via the wireless interface, and, simultaneously, transmit information to or receive information from a second one of the plurality of subscriber devices via the AC power line.

10. The power supply device of claim 1, wherein the communication module is further operable to receive a total amount of power consumption of the subscriber premises from a power meter, and transmit the total amount of power consumption to the network interface device.

11. The power supply device of claim 1, wherein the communication module comprises a power line communication (PLC) interface operable to modulate the information onto the power line to transmit information via the power line, and demodulate the information on the power line to receive information via the power line.

12. The power supply device of claim 1, wherein the communication module is further operable to receive information from one or more of the subscriber devices, and wherein information received from the one or more of the subscriber devices comprises at least one of power consumption by the one or more of the subscriber devices, and times of operation of the one or more of the subscriber devices.

13. A method comprising:
supplying power, with a power supply device, to a network interface device;
with the power supply device, receiving information from the network interface device;
with the power supply device, transmitting information to one or more of a plurality of subscriber devices within a subscriber premises via a wireless interface; and
with the power supply device, transmitting information to one or more of the subscriber devices within the subscriber premises via a power line within the subscriber premises.

14. The method of claim 13, further comprising:
selectively transmitting information to or receiving information from at least one of the plurality of subscriber devices via either the wireless interface or the power line.

15. The method of claim 14, further comprising:
receiving instructions that indicate whether the power supply device should selectively transmit information to or receive information from the at least one of the plurality of subscriber devices via either the wireless interface or the power line.

16. The method of claim 14, further comprising:
selectively transmitting information to or receiving information from the at least one of the plurality of subscriber devices via either the wireless interface or the power line based on one or more of a signal-to-noise ratio (SNR), a packet retry rate, a bit error rate, and a bit rate associated with transmitting and receiving information via the power line and via the wireless interface.

17. The method of claim 13, further comprising:
with the power supply device, transmitting information to the network interface device;
with the power supply device, receiving information from one or more of the subscribe devices via the power line within the subscriber premises; and
with the power supply device, receiving information from one or more of the subscriber devices via the wireless interface.

18. The method of claim 13, wherein the power line within the subscriber premises comprises an alternating current (AC) power line that extends within the subscriber premises.

19. The method of claim 13, wherein the wireless interface is coupled to the power supply device.

20. The method of claim 13, wherein the power supply device includes the wireless interface.

21. The method of claim 13, further comprising:
transmitting information to or receiving information from a first one of the plurality of subscriber devices via the wireless interface; and
simultaneously transmitting information to or receiving information from a second one of the plurality of subscriber devices via the power line.

22. The method of claim 13, further comprising:
receiving a total amount of power consumption of the subscriber premises from a power meter; and
transmitting the total amount of power consumption to the network interface device.

23. The method of claim 13, further comprising:
receiving information from one or more of the subscriber devices via the power line,
wherein transmitting information via the power line comprises modulating the information onto power line, and wherein receiving information via the power line comprises demodulating the information on the power line.

24. The method of claim 13, further comprising:
receiving information from the one or more of the subscriber devices,
wherein the information received from the one or more of the subscriber devices comprises at least one of power consumption by the one or more of the subscriber devices, and times of operation of the one or more of the subscriber devices.

25. A system comprising:
a plurality of subscriber devices at a subscriber premises;
a power line within the subscriber premises;
a wireless interface;
a network interface device; and
a power supply device operable to supply power to the network interface device, transmit information to and receive information from the network interface device, transmit information to and receive information from one or more of the plurality of subscriber devices within the subscriber premises via the power line within the subscriber premises, and transmit information to and receive information from one or more of the subscriber devices via the wireless interface.

26. The system of claim 25, wherein the power supply device is further operable to selectively transmit information to or receive information from at least one of the plurality of subscriber devices via either the wireless interface or the power line.

27. The system of claim 26, wherein the power supply device is further operable to receive instructions from the network interface device that indicate whether the power supply device should selectively transmit information to or receive information from the at least one of the plurality of subscriber devices via either the wireless interface or the power line.

28. The system of claim 26, wherein the power supply device selectively transmits information to or receives information from the at least one of the plurality of subscriber devices via either the wireless interface or the AC power line based on one or more of a signal-to-noise ratio (SNR), a packet retry rate, a bit error rate, and a bit rate associated with transmitting and receiving information via the AC power line and via the wireless interface.

29. The system of claim 25, wherein the power supply device is further operable to transmit information to or receive information from a first one of the plurality of subscriber devices via the wireless interface, and, simultaneously, transmit information to or receive information from a second one of the plurality of subscriber devices via the AC power line.

30. The system of claim 25, wherein the network interface device comprises an optical network terminal (ONT), and wherein the ONT is operable to transmit information to and receive information via an optical link.

31. The system of claim 25, further comprising a power meter operable to measure a total amount of power consumption of the subscriber premises, wherein the power supply device is further operable to receive the total amount of power consumption of the subscriber premises from a power meter, and transmit the total amount of power consumption to the network interface device.

32. The system of claim 25, wherein the information received from the one or more of the plurality of subscriber devices comprises at least one of power consumption by the one or more of the plurality of subscriber devices, and times of operation of the one or more of the plurality of subscriber devices.

33. A power supply device comprising:
means for supplying power to a network interface device;
means for receiving information from and transmitting information to the network interface device;
means for transmitting information to and receiving information from one or more of a plurality of subscriber devices within a subscriber premises via a wireless interface; and
mean for transmitting information to and receiving information from one or more of the plurality of subscriber devices within the subscriber premises via a power line within the subscriber premises.

34. The power supply device of claim 33, further comprising:
means for selectively transmitting information to or receiving information from at least one of the plurality of subscriber devices via either the wireless interface or the power line.

35. The power supply device of claim 34, further comprising:
means for receiving instructions that indicate whether the power supply device should selectively transmit information to or receive information from the at least one of the plurality of subscriber devices via either the wireless interface or the power line.

36. The power supply device of claim 34, further comprising:
means for selectively transmitting information to or receiving information from the at least one of the plurality of subscriber devices via either the wireless interface or the power line based on one or more of a signal-to-noise ratio (SNR), a packet retry rate, a bit error rate, and a bit rate associated with transmitting and receiving information via the power line and via the wireless interface.

37. The power supply device of claim 33, further comprising:
means for transmitting information to or receiving information from a first one of the plurality of subscriber devices via the wireless interface; and
means for simultaneously transmitting information to or receiving information from a second one of the plurality of subscriber devices via the power line.

38. The power supply device of claim 33, further comprising:
means for receiving a total amount of power consumption of the subscriber premises from a power meter; and
means for transmitting the total amount of power consumption to the network interface device.

39. The power supply device of claim 33, wherein the information received from the one or more of the subscriber devices comprises at least one of power consumption by the one or more of the subscriber devices, and times of operation of the one or more of the subscriber devices.

40. A power supply device operable to:
supply power to a network interface device;
receive information from the network interface device;
transmit information to one or more of a plurality of subscriber devices within a subscriber premises via a wireless interface; and
transmit information to one or more of the subscriber devices within the subscriber premises via a power line within the subscriber premises.
